(19) United States
(12) Patent Application Publication
(10) Pub. No.: US 2020/0202469 A1
(43) Pub. Date: Jun. 25, 2020

(54) SYSTEM AND METHOD FOR SELECTING AT LEAST ONE PREFERRED EDUCATIONAL INSTITUTION

(71) Applicant: Corsava, LLC, Seattle, WA (US)

(72) Inventor: Anne Wager, Seattle, WA (US)

(21) Appl. No.: 16/531,459

(22) Filed: Aug. 5, 2019

Related U.S. Application Data
(63) Continuation of application No. 15/583,924, filed on May 1, 2017, now abandoned.
(60) Provisional application No. 62/331,009, filed on May 3, 2016.

(51) Int. Cl. G06Q 50/20; G06F 16/2457; G06F 16/22

(52) U.S. Cl. CPC G06Q 50/2053; G06F 16/2282; G06F 16/24578

(57) ABSTRACT

The invention disclosed herein provides systems and methods for selecting at least one educational institution form a plurality of educational institutions.

### CROSS-REFERENCES TO RELATED APPLICATIONS

This Application takes priority to, U.S. application Ser. No. 15/583924, files on May 1, 2017, which takes priority from Provisional Application No. 62/331,009, filed on May 3, 2016; and incorporates both applications herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

Every year, hundreds of thousands of students search for the college and/or university (hereinafter referred to college either together or separately) that will best fit their needs. Most of these students contact a counselor, either private or public, to help them through this process. Both counselors and students may feel overwhelmed by the process.

Counselors may feel that they do not have enough time to spend with each student. Most counselors have no budget or time to do the research that is required to stay up-to-date on the programs and qualities each college offers. Some counselors use websites, guidebooks, or even their own notes when advising students. It is difficult for counselors to keep track of this information. Existing software solutions are expensive and in some cases, try to replace the guidance that can only be provided by a trained counselor. Additionally, software solutions may not provide up-to-date information.

Most students cannot afford to hire a private counselor who can advise the student on college choices. Students may not have vetted online resources to rely on. Many online resources are not trustworthy or are sponsored. Some students may receive unsolicited informational bulletins or pamphlets from colleges which simply confuse the students. Some students may not know how to build a college list, how to compare colleges, or even what they want out of a college. Some students may not know how to connect with colleges; the process may be overwhelming and intimidating. Some families end up relying on college valuing to make college choices without a real understanding of whether the college is suited to the student. And, in some cases, parents may not have any productive way to get involved in the process to choose a college.

### BRIEF DESCRIPTION OF INVENTION

The invention disclosed herein provides systems and methods for selecting at least one preference from a plurality of preferences.

### DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a flow chart showing an embodiment of the invention described herein;

FIG. 2 is chart of showing exemplary categories and attributes;

FIG. 3 is a chart showing an exemplary attribute and exemplary valuation method;

FIG. 4 is a flow chart showing an embodiment showing how attributes are discovered;

FIG. 5 is a flow chart showing an embodiment of information flow from a data table;

FIG. 6 is an exemplary report showing valued attributes;

FIG. 7 is a flow chart showing an embodiment of the disclosed invention;

FIG. 8 is a flow chart showing an embodiment of the disclosed invention.

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting. Given by way of overview, illustrative embodiments include system and method to allow a first user (110) to select at least one preferred educational (50) institution from a plurality of educational institutions (50) based on preferred attributed (30).

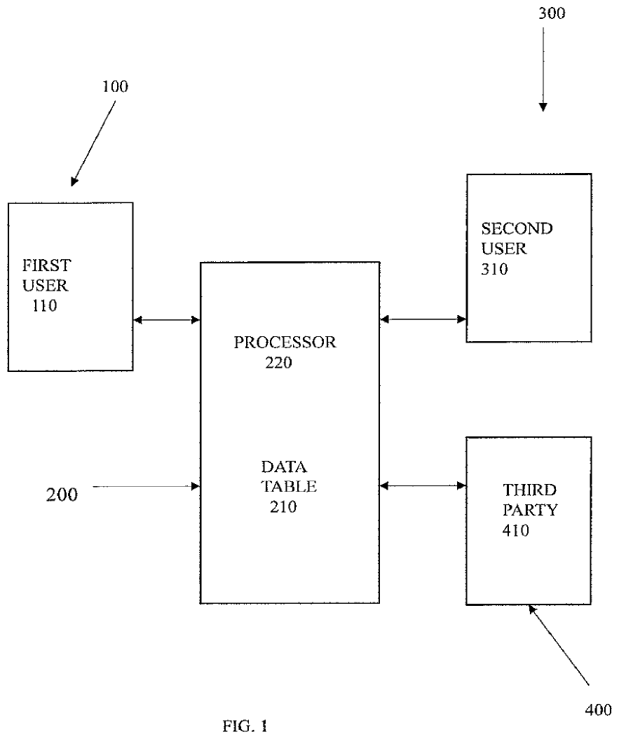

Referring to FIGS. 1, 2, and 7, according to one embodiment, a first user (110), generally a student or parent, values at least one attribute (30) where each attribute is related to at least one educational institution or preference (50). (1) In embodiments, the first user (110) may value attributes stored on at least one data table (210) located on at least one general purpose computer (200) having at least one processor (220). According to one embodiment, valued attributes (30) are compiled and at least one preference (50) is provided to the first user (110). (2)

According to an embodiment, attributes (30) may be organized by category (20). Categories (20) may include Academics, Campus Culture, Educational Culture, Extra Curricular Activities, Residential Life, Student Resource, amongst others. For example, the category (20) Campus Culture may include attributes (30) such as creative culture, diverse campus, friendly campus, party school, social justice, amongst others.

According to one embodiment, the at least one attribute (30) is provided to the first user (110) on a computing device associated with the first user (100). According to one embodiment, a first user (110) may value an attribute (30) by touching or clicking the attribute (30). (1) According to another embodiment, an attribute (30) is displayed on the touch sensitive device where a first user can value an attribute by selecting a digital icon (40) located on the attribute (30). (1)

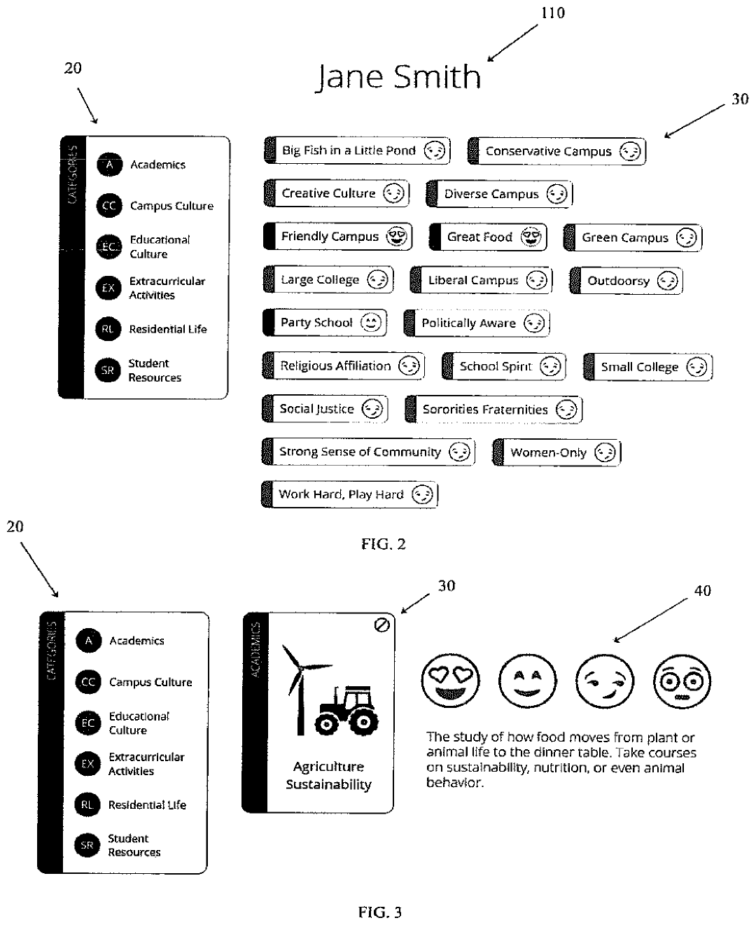

Referring to FIG. 3, according to one embodiment, at least two digital icons (40) may be located on an attribute (30). For example, attributes (30) may be valued by digital icons (40) that appear as an “in love” face (40) for an attribute (30) that has a high value and a “questioning face” icon (40) used to vale an attribute (30) with a low value. Other digital icons (40) may include thumbs-up and a thumbs-down rating model, selecting from one star to a plurality of stars, amongst others. In one embodiment, the first user may choose which attributes (30) he/she wishes to consider. For example, in FIG. 2, the first user (110) chose not to consider, or value, “Big Fish in a Little Pond”, “Conservative Campus”, “Women Only”, amongst others.

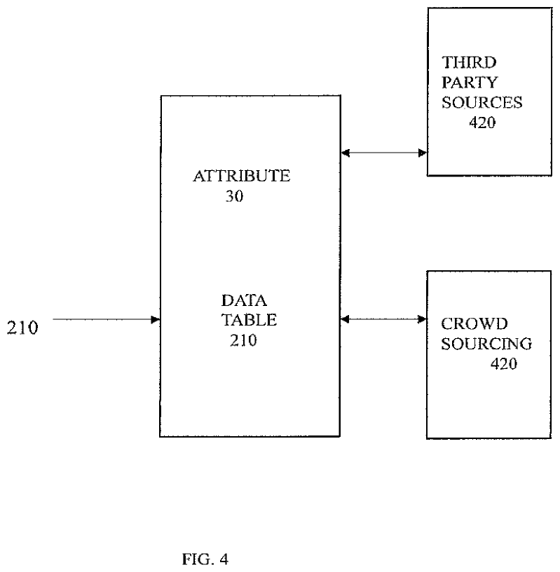

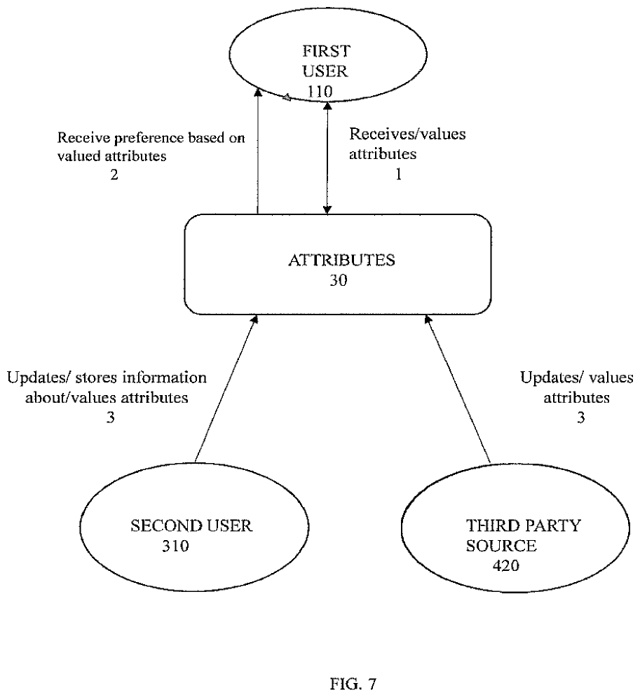

Referring to FIGS. 4 and 7, according to one embodiment, attributes (30) related to an educational institution (50) may be provided by third-party sources (420) (e.g. public data bases, third-party literature, etc.), crowdsourcing (e.g. student, parent or counselor insight) (430), or a combination thereof. (3)

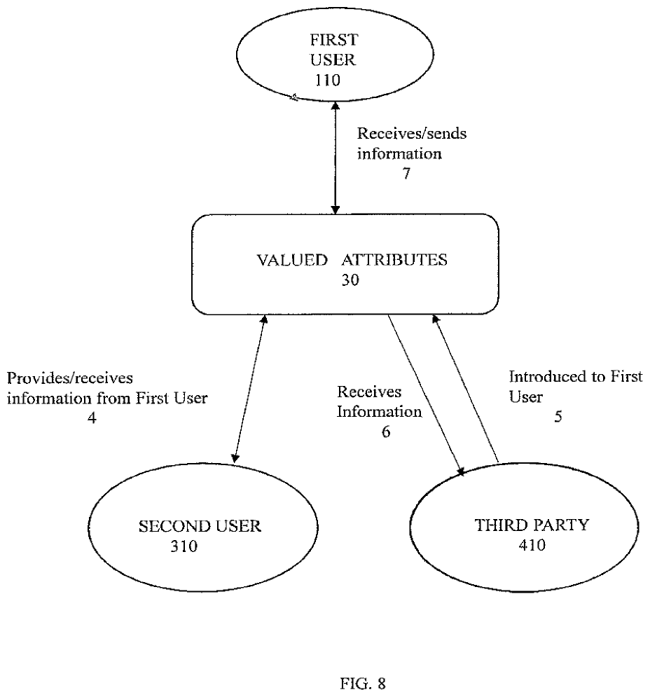

Referring to FIGS. 1 and 8, according to one embodiment, the second user (310) may update or provide new or different attributes (30) related to at least one educational institution (50). (4) According to one embodiment, monetary or other payment is made for crowdsourced information.

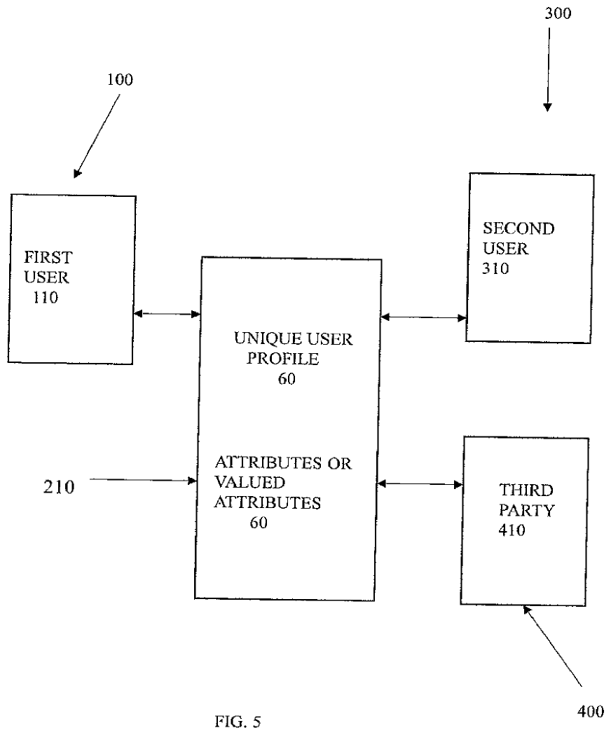

Referring to FIGS. 5 and 8, according to one embodiment, the first user (110), from a computing device associated with the first user (100), may create a unique user profile (60) that may be associated with the first user (110) valued attributes (30). According to one embodiment, the unique user profile (60) may be comprised of profile information which includes at least one member selected from a group consisting of: first user age, first user grade level, first user location, first user profile data of similar users, time of day the first user accesses the at least one stored stat table, social interaction of the first user, first user interests, first user preferred language, and first user demographic information. According to one embodiment, a second user (310), generally a counselor, (310), may access to valued attributes (30) and a related unique user profile (60). (4) According to embodiments, the second user (310) may access valued attributes (30) from a computer (300) associated with the send user (310).

According to one embodiment, the second user (310) may ask the first user (110) a particular question, allow a second user (310) to add additional advice and/or information for a first user (110) to review, or a combination thereof, amongst others. (4) According to one embodiment, the second user (310) may store college related references such as website links, pamphlets, notes on a data table (210) that may be accessed by the first user (110) or the second user (310). (4)

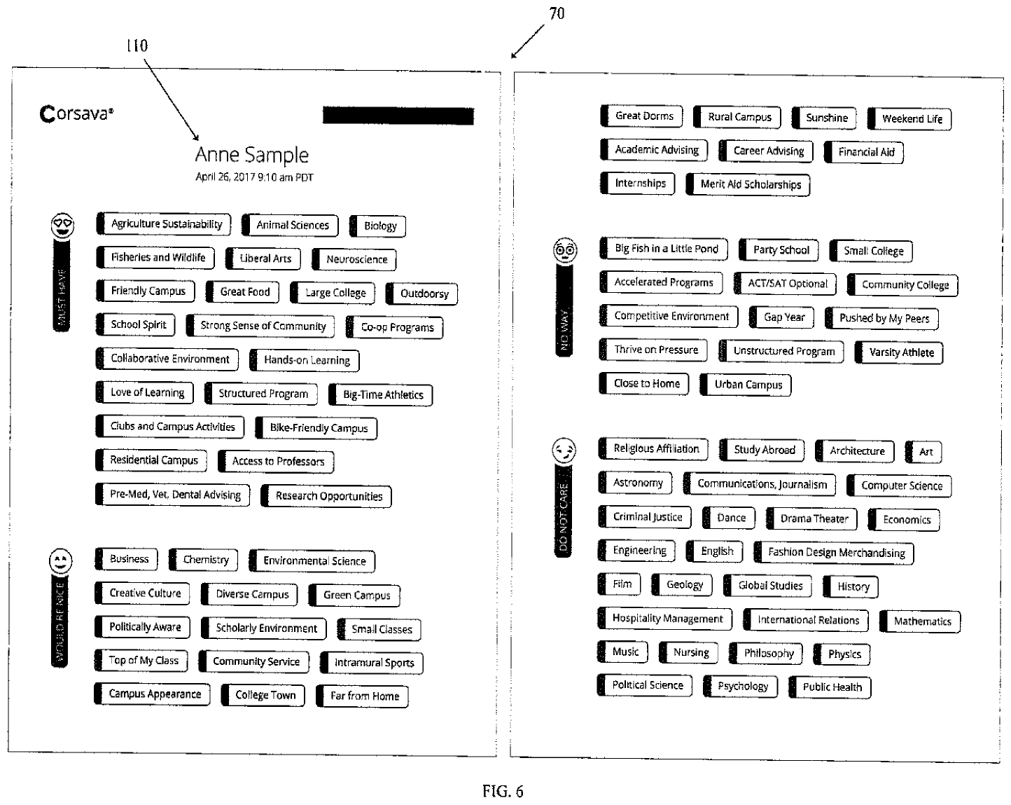

Referring to FIG. 6, the first user (110) or the second user (310) may generate a report (70) of the first user's (110) valued attribute (30). According to an embodiment, the report (70) may be an optionally printable PDF or a tokenized URL (70).

Referring to FIGS. 5 and 8, according to one embodiment, a second user (310) may be able to schedule a meeting with a first user (110). (4) According to an embodiment, a third-party (410), generally an educational institution (50), may be introduced to a first user (110). According to an embodiment, a third party (410) may be introduced to a first user (110) based on first user (110) unique user profile (60). (5) According to one embodiment, a third party (410) may be introduced to a first user (110) based on first user (110) valued attributes (30). (5) According to embodiments, the third party (410), from a computer associated with the third party (400), may be introduced to a first party (110), on a computer associated with the third party (400).

According to one embodiment, a third party (410) may access attributes (30) listed in the data table (210). (6) According to one embodiment, a third party (410) may access aggregated valued attributes (30) of more than one first user (110) stored in a data base (210). (6) According to an embodiment, a third party (50) may have access to at least a first user (110) unique user profile (60) and valued attributes rated by the same first user (110). (6) According to an embodiment, a third party (410) may access attributes (60) stored in a data table (210) related to at least one educational institution (50).

According to some embodiments, artificial intelligence may be used to determine educational institutions that have attributes (30) which are the same or similar to highly ranked educational institutions (50).

Referring to FIGS. 1-6, in embodiments, the present invention may provide for a computer program product embodied in a computer readable medium that, when executing on one or more computers, provides system and method to allow a first user (110) to select at least one educational (50) institution from a plurality of educational institutions (50) based on preferred attributed (30) by performing the steps comprising: (1) receiving a request from a first user (110) for more than one attribute (30) which are indicative of a preference for at least one educational institution, or preference, (50); (2) identify more than one attribute (30) responsive to the request; (3) provide the identified more than one attribute (30) to the first user (110); (4) allow the first user (110) to value the identified attribute (30); (5) store the first user's (110) valued attributes (30); (5) determine educational institution (50) based on valued attributes (50). In embodiments, attributes (30) are generated by third party sources (420), first users (110), second users (310), or a combination thereof. In embodiments, a third party (410) may access attributes (30) or aggregated valued attributes (30). In embodiments, a first user (110) and a third party (410) may be introduced.

The methods and systems described herein may be deployed in part or in whole through a machine that executes computer software, program codes, and/or instructions on a processor. The present invention may be implemented as a method on a machine, as a system or apparatus as of or in relation to the machine, or as a computer program product embodied in computer readable medium executing on one or more of the machines. The processor may be part of a servicer, client, network infrastructure, mobile computing platform, stationary computing platform, or other computing platform. A processor may be any kind of computational or processing device capable of executing program instructions, codes, binary instructions and the like. The processor may be or includes a single processor, digital processor, embedded processor, microprocessor, or any variant such as a co-processor (math co-processor, graphic co-processor, communication co-processor and the like) and may directly or indirectly facilitate execution of multiple program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have been assigned priorities associated with them; the processor may execute these threads based on priority or any other order based on instructions provided in the program code. The processor may include memory that stores methods, codes, instructions and programs as described herein and elsewhere. The processor may access a storage medium associated with the processor to storing methods, programs, codes, program instructions or other types of instruction capable of being executed by the computing process device may include but may not be limited to one or more of CD-ROM, DVD, memory, hard disk, flash drive, RAM, ROM, cache, and the like.

A processor may include one or more cores that may enhance speed and performance of a multiprocessor. In embodiments, the processor may be a dual core processor, quad core processor, or other chip level multiprocessor and the like that combine two or more independent cores (called a die).

The methods and systems described herein may be deployed in part or in whole through a machine that executes computer software on a server, client, firewall, gateway, hub, router, or other such computer or networking hardware. The software program may be associated with a server that may include a file server, print server, domain server, internet server, intranet server, and other variant such as secondary server, host server, distributed server, and the like. The server may include one or more of memories, processors, computer communication devices, and interfaces capable of accessing other client servers, clients, machines, and devices through wired or wireless medium, and the like. The methods, programs or codes described herewith and elsewhere may be executed by the server. In addition, other devices required for execution of methods as described in this application as part of an infrastructure associated with the server.

The server may provide an interface to other devices including, without limitation, clients, other servers, printers, database servers, print servers, file servers, communication servers, distributed servers and the like. Additionally, this coupling and connection may facilitate remote execution of program across the network. The networking of some or all of these devices may facilitate parallel processing of a program or method at one or more locations without deviating from the scope of the invention. In addition, any of the devices attached to the server through an interface may include at least one storage medium capable of storing methods, programs, code and/or instructions to be executed on different devices. In this implementation, the remote repository may act as a storage medium for program code, instructions, and programs.

The software program may be associated with a client that may include a file client, print client, domain client, internet client, and other variants such as secondary clients, host clients, distributed clients and the like. The client may include one or more memories, processors, computer readable media, storage media, ports (physical and virtual). Communication devices, and interfaces capable of accessing other clients, servers, machines, and devices, and interfaces capable of accessing other clients, servers, machines, and devices, through a wired or wireless medium, and the like. The methods, programs or codes as described herein and elsewhere may be executed by the client. In addition, other devices required for execution of the methods as described herein this application may be considered as a part of the infrastructure associated with the client.

The client may provide an interface to other devices including without limitation, servers, other clients, printers, data based servers, file servers, communications servers, distributed servers and the like. Additionally, coupling and/or connection may facilitate remote execution of program across the network. The networking of some or all of the devices may facilitate parallel processing of a program or method at one or more locations without deviating from the scope of this invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The method and systems described herein may be deployed in part or in whole through network infrastructures. The network infrastructure may include elements such as computing devices, servers, routers, hubs, firewalls, clients, personal computers, communication devices, routing devices, and other active and passive devices, modules and/or components known in the art. The computing and or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements. The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be GSM, GPRS, #G 4G, EVDO, mesh, or other network types.

The methods, programs, codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as a flash memory, buffer, RAM, ROM, and one or more computing devices. The computing devices associated with mobile devices may be enabled to execute program codes, methods, and instructions stored thereon. Alternatively, the mobile device maybe configured to execute instructions in collaboration with other devices. The mobile devices may communicate on a peer to peer network. The program code maybe stored on the storage medium associated with the server and executed by a computing device embedded within the server. The base station may include a computing devices and a storage medium. The storage device may store program code and instructions executed by computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage such as optical discs, forms of magnetic storage, like hard disks, tapes, drums, cards, and other types; processor registers, cache memory, volatile memory, non-volatile memory, optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, network attached storage, file addressable, content addressable, network, barcodes, magnetic ink, and the like.

The methods and systems described herein may transform physical and/or intangible items from one state to another. The methods and systems or intangible items from one state to another. The methods and systems described herein may also transform data representing physical and/or intangible items from one state to another.

The elements described and depicted herein, including flow charts and block diagrams throughout the figures, imply logical boundaries between the elements. However, according to software or hardware engineering practices, the depicted elements and functions thereof may be implemented on machines through computer executable media having a processor capable of executing program instructions, as standalone software modules, or as modules that employ external routines, codes, services, and so forth, or any combination of these, and all such implementations maybe within the scope of the present disclosures. Examples of such machines may include, but may not be limited to, personal digital assistants, laptops, personal computers, mobile phones, other handheld computing devices, medical equipment, wired or wireless communication devices, transducers, chips, calculators, sat-ellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps hereof, may be realized in hardware, software or any combination of hardware and software suitable for an application. The hardware may include a general-purpose computer and/or dedicated computing device or specific computing device or aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in several ways, or all the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed:

1. A method for helping a first user select a preferred educational institution from a plurality of educational institutions implemented on a general-purpose computer with processor-executable program instructions configured to direct at least one processor and at least one stored data table including data useful for predictive analysis, for selecting or providing a predilection for at least one educational institution from a plurality of educational institutions comprised of:
receiving, by the processor, a request to provide, to a computing device associated with a first user, more than one attribute which are indicative of a preference for at least one educational institution;
identifying, by the processor, more than one attribute responsive to the request stored on at least a first data table;
providing, from the at least first data table, for a display on the computing device associated with the first user, the identified attributes;
allowing, by the processer, the first user to value the identified attributes;
storing, the first user's valued attributes stored on at least a second data table;
providing, for display on the computing device associated with the first user, the valued attributes or ranked valued attributes;
providing, for display on the computing device associated with the first user, at least one preferred educational institution based on first user rated attributes.

2. The method according to claim 1, further comprising providing, for display on a computing device associated with a second user, the valued attributes or ranked valued attributes of the first user.

3. The method according to claim 1, further comprising, allowing, by the processor, the second user to, from a computing device associated with the second user, value attributes and/or identify new attributes for an educational institution.

4. The method according to claim 1, further comprises, allowing the first user, by the processor, to create a unique user profile; wherein the first user unique user profile is comprised of profile information which includes at least one member selected from a group consisting of: first user age, first user grade level, first user location, first user profile data of similar users, time of day the first user accesses the at least one stored stat table, social interaction of the first user, first user interests, first user preferred language, and first user demographic information.

5. The method according to claim 4, further comprising, allowing, by the processor, a second user to access the first user's unique user profile.

6. The method according to claim 5, further comprising, providing, for display on the computing device associated with the second user, the valued attributes or ranked valued attributes associated with the first user's unique user profile.

7. The method according to claim 6, further comprising, allowing, by the processor, the second user to deliver to the computing device associated with the first user a request that the first user value additional attributes or request additional information about a particular attribute.

8. The method according to claim 6, further allowing, by the processor, the second user to provide, for display on the computing device associated with the first user, information regarding at least one educational institution.

9. The method according to claim 6, further comprises, allowing, by the processor, the provided display on the computing device associated with the first user or a computing device associated with the second user, the rated attributes or valued rated attributes to be provided as a PDF and/or as a tokenized URL.

10. The method according to claim 1, further comprising, allowing, by the processor, at least one third-party, from a computing device associated with the third party, to populate the at least one data table with attributes.

11. The method according to claim 1, further comprising, allowing, by the processor, at least a third party to access, from a computing device associated with the third party, at least a first user profile and attributes rated by the first user, aggregated valued attributes valued by more than one user, or attributes related to at least one educational institution.

12. The method according to claim I, further comprising, introduction, by the processor, of at least a first user, on a computing device associated with the first user, to at least a third party.

13. The method according to claim 1, further comprising, populating attributes in at least the first data base from third party sources our crowdsourcing.

14. A system for helping a user select a preferred educational institution from a plurality of educational institutions on a computing device associated with a user, the system comprising:
a processor;
a memory having at least one data table;
a memory having instruction stored thereon, wherein the instructions, when executed, cause the processor to:
receiving a request from a first user for more than One attribute, stored on the data table, which are indicative of a preference for at least one educational institution;
identify more than one attribute responsive to the request;
provide the identified more than one attribute to the first user;
allow the first user to rate the identified attributes;
store the first user's rated attributes;
determine at least on preferred educational institution based on rated attributes. provide the first user a valued list or list of rated attributes for later review.

15. The system according to claim 14, displaying for a second user, the rated attributes or the valued rated attributes of the first user.

16. The system according to claim 14, further comprises allowing the first user to create a unique user profile; wherein the unique user profile is profile information includes at least one member selected from a group consisting of: first user age, first user grade level, first user location, first user profile data of similar users, time of day the first user accesses the at least one stored stat table, social interaction of the first user, first user interests, first user preferred language, and first user demographic information.

17. The system according to claim 16, further comprising, allowing a second user to access the first user's unique user profile.

18. The system according to claim 17, further comprising, providing the second user the rated attributes or valued rated attributes associated with the first user's unique identifier.

19. The system according to claim 18, further comprising, allowing the second user to request the first user to rate additional attributes or provide more information about a particular attribute.

20. The system according to claim 18, further comprising, allowing the second user to provide the first user information regarding at least one educational institution.

21. The system according to claim 18, further comprises, allowing the valued rated or rated attributes rated of the first user to be provided as a PDF and/or as a tokenized UR to the first user and/or second user for later viewing.

22. The system according to claim 14, further comprising, allowing a second user to rate attributes and/or identify new attributes for an educational institution; where such valuing or new attributes are stored in the data table.

23. The system according to claim 14, further comprising, allowing at least one third party to populate the data table with attributes.

24. The system according to claim 14, further comprising, allowing at least one third party to access at least a first user profile and attributes rated by the first user, aggregated valued attributes valued by more than one user, or attributes related to at least one educational institution

25. The system according to claim 14, further comprising, introduction of at least a first user to at least a third party.
